(19) United States
(12) Patent Application Publication
(10) Pub. No.: US 2006/0151116 A1
(43) Pub. Date: Jul. 13, 2006

(54) Focus rings, apparatus in chamber, contact hole and method of forming contact hole

(75) Inventor: I-Chang Wu, Hsin-chu (TW)

Correspondence Address: DUANE MORRIS, LLP;IP DEPARTMENT, 30 SOUTH 17TH STREET, PHILADELPHIA, PA, 19103-4196, US

(73) Assignee: Taiwan Semiconductor Manufacturing Co., Ltd.

(21) Appl. No.: 11/035,324

(22) Filed: Jan. 12, 2005

(51) Int. Cl. C23F 1/00; C03C 25/68

(52) U.S. Cl. 156/345.46; 216/58

(57) ABSTRACT

Focus rings, an apparatus in a chamber, a method of forming a contact hole structure and a contact hole structure are provided. The focus ring of a chamber substantially covers a part of a stage so as to prevent formation of particles on or near to an edge of the stage. Due to the application of the focus rings, build up of polymer particles on or near to the edge of the support ring can be substantially prevented.

### BACKGROUND OF THE INVENTION

1. Field of the Invention

The present invention relates to the apparatus for ,and fabrication method of, integrated circuit devices on semiconductor substrates and, more particularly relates to focus rings, an apparatus in a chamber, a method of forming a contact hole structure and a contact hole structure.

2. Description of the Related Art

Two processes that are performed numerous times during the fabrication of a semiconductor device are a lithographic patterning of a photosensitive layer on a substrate and an etch transfer of the pattern into the substrate. A semiconductor device has several layers of metal wiring that are commonly called interconnects. In one example, an interconnect is constructed by forming an opening such as a contact hole in a photoresist layer, employing a fluorocarbon gas to generate a plasma to etch through one or more dielectric layers, and filling the opening with a metal. The width of the opening typically has a tight specification, so that a uniform metal line width is achieved in order to control the speed and performance of the device.

There are numerous other examples in which a plasma etch process is employed to transfer a pattern from one layer into an underlying layer. In each case, the size or critical dimension (CD) of an opening is initially defined by fine tuning a lithography process. However, the subsequent etch process must also be optimized so that the CD of the opening in the photoresist layer is maintained within the desired limits in underlying layers. Secondly, a good etch process is one in which the rate of removal of one or more layers from within all openings in the pattern is done evenly across the wafer. Hence, there is a constant drive to improve etch rate uniformity.

Although wafer-to-wafer CD control and uniformity requires much effort, within-wafer etch uniformity is especially challenging since the intensity of the plasma tends to be higher in a region near the periphery of the wafer and often overlaps the edge of the wafer. For this reason, a component called a focus ring is placed around the edge of the wafer, which is on a pedestal or on an electrostatic chuck (e-chuck). The focus ring confines the plasma to a region above the wafer surface and thereby improves etch uniformity between the inner and outer regions of a wafer. Since the focus ring and an underlying support piece—which in one form is a support ring—are situated in close proximity to the wafer, a fluorocarbon polymer buildup that occurs on surfaces within the chamber gradually collects on the exposed parts of the support ring. A polymer build up is not observed on the focus ring which is comprised of quartz or a similar material that reacts with the etchant and is eroded away.

The fluorocarbon polymer build-up on the support ring is significant, since the material may flake off to form particles which contaminate a wafer and result in a loss of product yield. For example, a particle on a product wafer may lead to an open in a metal line that causes a disruption of an electrical current or may result in a bridge or “short” between two metal lines that has a deleterious effect on device performance. Therefore, a process that minimizes particle defects is needed as ground rules or CD shrinks to 130 nm or less in new technologies.

A side benefit of reducing polymer buildup on a support piece for a focus ring is that the amount of time required for preventative maintenance to keep the tool in good working order and the time needed for wet cleaning operations to remove polymer deposits from within the chamber is reduced. Furthermore, less monitor wafers are necessary to check the particle defect count during an etch process. These factors add up to a cost savings because of a higher tool availability for processing product wafers.

FIG. 1 is a schematic cross sectional view showing a prior art etch chamber. Referring to FIG. 1, a representative process chamber 10 that has been previously employed by the inventors is shown. The process chamber 10 has an outer wall 11 and may be part of an etch tool that has other process chambers (not shown). The process chamber 10 is equipped with a plasma generating device (not shown) that is based on a dipole ring magnet (DRM) technology. Optionally, other energy sources such as an antenna powered by a suitable RF source can be utilized.

The process chamber 10 is further defined as having a liner comprised of a sidewall 13 and a top section 12. The sidewall 13 may have ports for introducing one or more gases and likewise top section 12 has gas inlets that are preferably in the form of a gas distribution plate. Additionally, the top section 12 may be comprised of a dielectric window for efficient energy transfer from the plasma generating device into the process space 20. The lower region of process space 20 is bounded by an e-chuck 14 that is capable of holding a 200 mm diameter wafer 15, a focus ring 16 and a support ring 17. The process chamber 10 is also equipped with a vacuum system (not shown) that is capable of evacuating all gases from the process space 20 through an exit port that is not pictured and has a port (not shown) that is connected to an end point detection instrument for determining when the etch process through a particular layer is complete.

A plasma 19 comprised of CF⁺ ions is typically formed when etching layers on wafer 15 during fabrication of an interconnect structure. Plasma 19 can also contain electrons and neutral species. Other gases including oxygen containing gases and inert gases such as helium, argon, and N₂ may be fed with one or more fluorocarbon gases into the process space 20 to form plasma 19. A fluorocarbon polymer deposit 18 forms on exposed surfaces within process space 20 except on focus ring 16 which is typically comprised of quartz or a similar material that is partially consumed during the etch.

An enlarged view of a portion of FIG. 1 is illustrated in FIG. 2 in which a polymer buildup 18 is shown on horizontal and vertical surfaces of the support ring 17 adjacent to the focus ring 16 and the e-chuck 14. The wafer 15 is shown partially supported by a prior art focus ring 16. The focus ring 16 and the support ring 17 are movable parts. Unfortunately, some of polymer buildup 18 may flake off and some of these particles are deposited on the wafer 15 during the etch process or when the support ring 17 is moved to facilitate unloading of the wafer 15 after the plasma step is ended. After a total of about 25 hours of plasma etching, the prior art focus ring 16 is clean, but the particle count on a product wafer or on a monitor wafer used to check particle levels is above a specified limit. When the support ring 17 is replaced, the particle count on a monitor wafer that is measured following a usual etch process is found to be within specified limits which indicates the polymer buildup 18 on the support ring 17 is a significant contributor to formation of particle defects on the wafer 15.

The particles that are transferred from the support ring 17 to the wafer 15 are considered defects, since they may disrupt subsequent processes and lower device yield and/or performance. For instance, a particle may cover an opening and prevent a metal deposition process from forming an interconnect structure. There are several other ways known to those skilled in the art that a particle can be harmful to a device and will not be discussed herein. The polymer deposit 18 on the support ring 17 is also costly in terms of the down time associated with periodically performing preventative maintenance and wet cleaning on chamber parts in order to remove the polymer deposits 18.

In related art, the surface of a focus ring is roughened to a depth between 1 and 10 microns in U.S. Pat. No. 6,423,175 to enhance the adhesion of the deposited fluorocarbon polymer to the ring and prevent flaking off of particles. In this case, the focus ring has a flat base on a quartz cover ring and a perpendicular collar portion that extends above the wafer plane. However, the method does not include a means of improving etch uniformity.

In U.S. Pat. No. 6,508,911, a diamond layer is applied to a focus ring to improve the etch resistance and reduce wear on the ring.

A focus ring consisting largely of silicon nitride is mentioned in U.S. Pat. Nos. 5,993,594 and 6,251,793. Polymer buildup on a ring or other chamber components such as a gas distribution plate that are constructed of SiN occurs more slowly and the material does not flake off. No improvement in etch uniformity is reported.

A plasma processing apparatus in U.S. Pat. No. 6,506,686 includes a silicon focus ring that acts as a scavenger for F and CFx radicals to adjust etch uniformity at the edge of a wafer. Likewise, an etch ring is described in U.S. Pat. No. 6,337,277 that improves electrical and mechanical properties of an etch process at the edge of a substrate.

In U.S. Pat. No. 5,976,310 a plasma etch system and method is described for reducing particle contamination and improving etch uniformity that involves introducing an inert gas flow between a wafer perimeter and a plasma perimeter to prevent polymer from collecting on a focus ring. The apparatus has a pedestal and mechanical clamp design and is not necessarily compatible with newer etchers that are equipped with an e-chuck and a different style of focus ring.

Therefore, an apparatus and method are desired that incorporate an e-chuck design in the etching system and which simultaneously provide improved contamination control and deliver a better etch uniformity during removal of dielectric layers or photoresist layers while forming an integrated circuit that has a critical dimension of about 130 nm or less. The improvements should not only be applicable to etching 200 mm wafers but should also be useful for newer technologies that have 300 mm diameter wafers.

### SUMMARY OF THE INVENTION

In some embodiments, an apparatus in a chamber comprises a stage, a support ring and a focus ring. The support ring is around the stage. The focus ring is over the stage and the support ring, substantially completely covering a top surface of the support ring.

In some embodiments, etching apparatus comprises a chamber including: a stage, a support ring around the stage, and a focus ring over the stage and the support ring. The focus ring substantially completely covers a top surface of the support ring. A vacuum system evacuates the chamber. A a gas source provides a gas to the chamber for forming a plasma. Means are provided for generating an electric field in the chamber. Means are provided for generating a magnetic field in the chamber.

In some embodiments, a method for forming a contact hole structure includes providing a substrate over a stage with a support ring around the stage, and a focus ring substantially completely covering the support ring. An etch process is performed so as to form a contact hole structure in the substrate substantially without forming particles on or near to an edge of the support ring. In some embodiments, a contact hole structure is formed by the method described above.

The above and other features of the present invention will be better understood from the following detailed description of the preferred embodiments of the invention that is provided in connection with the accompanying drawings.

### BRIEF DESCRIPTION OF THE DRAWINGS

FIG. 1 is a schematic cross sectional view showing a prior art etch chamber.

FIG. 2 is an enlarged view of a portion of the chamber of FIG. 1 that depicts polymer deposition on a support ring.

FIG. 3 is a top view showing an example of a focus ring surrounding a wafer.

FIG. 4 is a schematic cross-sectional view that depicts the relative size and position of an exemplary focus ring in relation to a wafer and a support ring in a plasma etch chamber.

FIGS. 5-8 are schematic process sequence cross sectional drawings showing an exemplary method of forming a contact hole structure.

FIG. 9 is a cross sectional diagram of an exemplary etching apparatus according to one embodiment of the invention.

### DESCRIPTION OF THE PREFERRED EMBODIMENT

Following are descriptions of exemplary embodiments related to focus rings, an apparatus in a chamber, a method of forming a contact hole structure and a contact hole structure by protecting an adjacent support ring from polymer buildup. These embodiments are suitable for an etch chamber that has a DRM (dipole ring magnet) which generates a plasma etchant. However, other embodiments may use other methods of forming a plasma. The drawings serve to illustrate examples and are not intended to limit the scope of the invention.

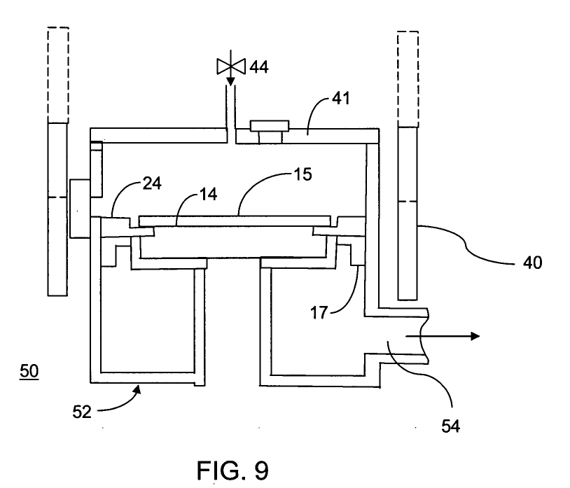

FIG. 9 is a cross sectional view of an exemplary etching apparatus 50 according to one embodiment of the invention. The apparatus 50 includes a chamber 52 comprising: a stage 14; a support ring 17 around the stage 14, and a focus ring 24 over the stage 14 and the support ring 17, substantially completely covering a top surface of the support ring 17. A vacuum system 54 evacuates the chamber 52; a gas source 44 provides a gas to the chamber 52 for forming a plasma. A means for generating an electric field in the chamber may include, for example, electrodes 14 and 41. A means for generating a magnetic field in the chamber may include, for example, a dipole ring 40 outside of the chamber, for generating a magnetic field perpendicular to the electric field and parallel to a surface of a wafer 15. Use of a dipole ring 40 provides a magnetic field of uniform strength to maintain a uniform high-density plasma over the whole surface of a wafer. Construction and use of an etching apparatus including a magnetic dipole ring is taught by U.S. Pat. 5,444,207, which is incorporated by reference in its entirety.

A reactive gas is supplied through a gas inlet 44 into a region in which the electric field and the magnetic field perpendicular to the electric field exist, so that plasma is generated by electric discharge. A self-bias electric field (self bias voltage Vdc) is induced on the surface of wafer 15 which accelerates ions in the plasma to impinge on the wafer 15 so as to advance the etching process.

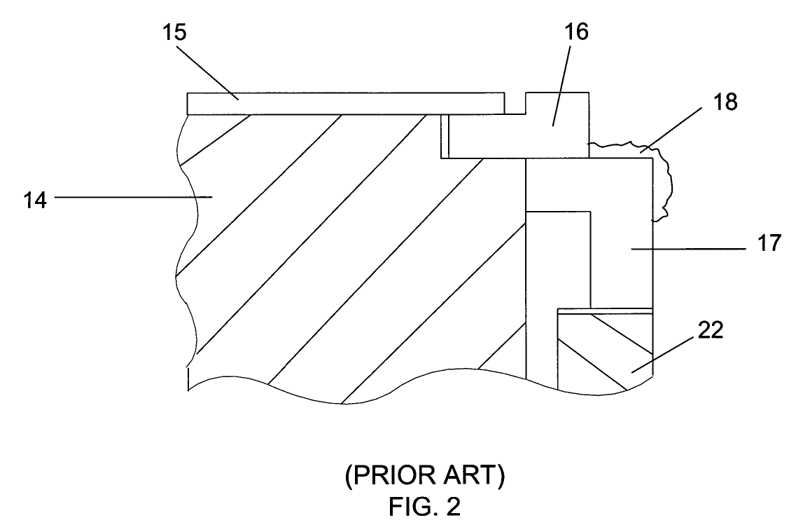

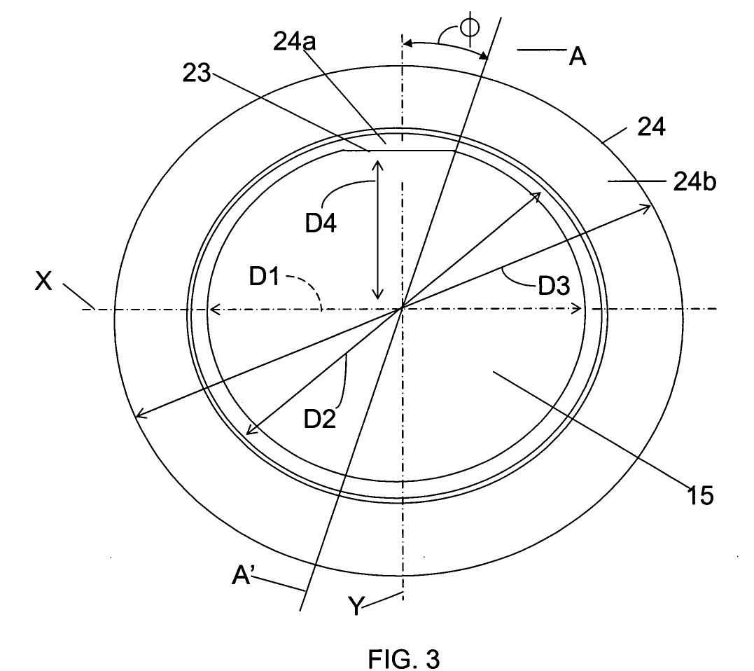

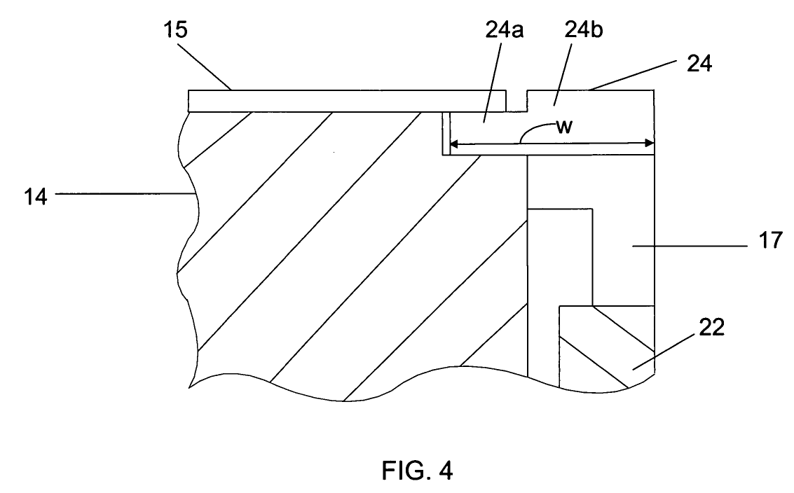

FIG. 3 is a top view showing an example of a focus ring surrounding a wafer. Referring to FIG. 3, the focus ring 24 that has an outer diameter of 280 mm—which is about 20 mm larger than prior art focus rings—is capable of preventing polymer buildup on or near to the edge of the support ring 17 and simultaneously improves etch rate uniformity during etch processes with a fluorocarbon plasma. In this embodiment, the prior art focus ring 16 shown in FIG. 2 is replaced by the focus ring 24 shown in FIG. 4. The view overlooking the center of a wafer 15 on the stage 14 depicts the flat edge 23 of the wafer 15 in an orientation that is parallel to one axis X and perpendicular to a second axis Y. The diameter D1 of the wafer 15 along the X axis is 200 mm while the distance D4 from the center of the wafer where the X and Y axes intersect to the flat edge 23 is about 97 mm. The distance D2 from the center of wafer 15 to the beginning of the outer portion 24b of focus ring 24 is about 203 mm while the diameter D3 of focus ring 24 is 280 mm. Most of the inner portion 24a of focus ring 24 underlies the perimeter of wafer 15. A line A-A′ through the center of wafer 15 which intersects with one end of flat edge 23 forms an angle Φ that is approximately 10°.

FIG. 4 is a schematic cross-sectional view that depicts the relative size and position of an exemplary focus ring in relation to a wafer 15 and a support ring 17 in a plasma etch chamber. Referring to FIG. 4 the top and bottom surfaces of inner portion 24a and outer portion 24b are horizontal. The inner portion 24a has an inner vertical sidewall that is adjacent to the stage 14 while the outer portion has a vertical sidewall. Although the wafer 15 is held in place by the stage 14, the wafer partially rests on an inner portion 24a of focus ring 24 that is thinner than the outer portion 24b of the focus ring. The height of the inner portion 24a of the focus ring 24 is from about 2 mm to about 3 mm and the height of the outer portion 24b which is coplanar with the surface of wafer 15 is from about 3 mm to about 4 mm. The focus ring 24 can be comprised of, for example, quartz. The focus ring 24 is partially eroded in a fluorocarbon containing plasma and must be replaced after about 30 hours of service.

The width w of the focus ring 24 can be such that the vertical wall of outer portion 24b forms a coextensive or coplanar surface with the vertical outer sidewall of support ring 17, as shown in FIG. 4. The coextensive or coplanar surface is designed to substantially completely cover the top surface of support ring 17 to prevent polymer buildup that can lead to contamination. The focus ring 24 has a beneficial effect on etch rate uniformity and improves etch uniformity during removal of silicon nitride, oxide, and photoresist layers. It is not necessary that the focus ring 24 completely covers the support ring 17. As long as a sufficient portion of the support ring is covered, so that the polymer build-up on or near to the edge of the support ring 17 would not cause a substantial particle contamination issue, the partial covering of the top surface of the support ring 17 is sufficient. In some embodiments, the focus ring 24 may even wrap around the edge to cover a portion of the sidewall of the support ring 17, so as to prevent the polymer deposition thereon. One of ordinary skill in the art, after reading the descriptions of this embodiment, will understand how to change or modify the size and shape of the focus ring 24.

In this embodiment, only the focus ring 24 needs to be replaced (and not the support ring 17) when performing a wet clean of the process chamber. Furthermore, the time between wet cleaning and preventative maintenance steps is lengthened, which results in increased tool availability for production and lower production cost. Additional cost savings are realized because fewer monitor wafers are used to check particle counts, since a polymer buildup on the support ring is no longer a concern. Accordingly, a higher product yield results from fewer particle defects on wafers processed through an etch chamber having a wide-style focus ring as shown in FIG. 4.

In some embodiments, the process chamber and the stage 14 may be modified to handle a 300 mm wafer and other components including focus ring 24 are adjusted in size and shape, accordingly. D1 becomes 300 mm and D2 is slightly larger than 300 mm. Likewise, w is increased in size from the embodiment described above, so that the vertical wall of outer portion 24b forms a smooth surface with the vertical outer sidewall of support ring 17. The thickness of focus ring 24 may also become larger when D1 for wafer 15 is increased from 200 mm to 300 mm. However, similar advantages are realized when the apparatus is enlarged to accommodate 300 mm wafers since the focus ring 24 is designed to prevent polymer buildup 18 on support ring 17 and provides better etch uniformity. One of ordinary skill in the art, after viewing the descriptions of this embodiment, will understand that the focus ring is not limited to be applied to 200-mm or 300-mm equipment. It may also be used in 100-mm or 150-mm equipment by changing the size of the focus ring 24.

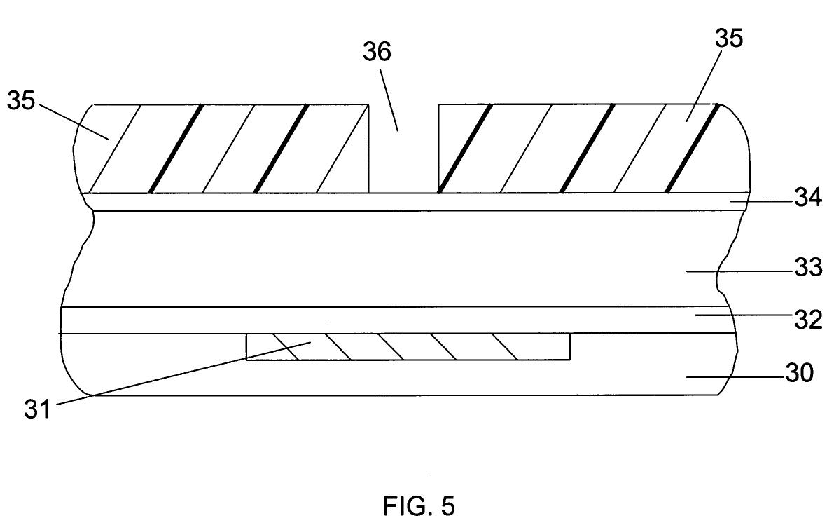

FIGS. 5-7 are schematic process sequence cross sectional drawings showing an exemplary method of forming a contact hole structure. The method involves etching a semiconductor substrate in an etch chamber that is equipped with the focus ring described above with reference to FIG. 4. The contact hole structure is fabricated according to this exemplary method. However, the invention is not limited to form a contact hole structure. It may be used to form a damascene structure and any substrate with a patterned upper layer having an opening that is to be etch-transferred into one or more underlying layers.

Referring to FIG. 5, a substrate 30 is provided that is typically silicon but may be based on silicon-germanium, gallium-arsenide, or silicon-on-insulator (SOI) technology, for example. The substrate 30 is further comprised of a metal layer 31 that can be W, Cu, AL or AL/Cu, for example. The substrate 30 typically may comprise dielectric and metal layers (not shown) formed thereon and active and passive devices that are not depicted in order to focus attention on the important aspects of this embodiment.

A stack of layers are formed on the substrate 30 by sequentially depositing an etch stop layer 32, a dielectric layer 33, and a cap layer 34. The etch stop layer 32 can be silicon carbide, silicon nitride, or silicon oxynitride that is typically formed by a chemical vapor deposition (CVD) or plasma enhanced CVD (PECVD) technique and protects the metal layer 31 during processing to form an opening in the stack. The dielectric layer 33 can be, for example, oxide or a low k dielectric material such as fluorine doped SiO₂, carbon doped SiO₂, a polysilsesquioxane, a poly(arylether), or a polyimide that has a dielectric constant of about 3 or below and is deposited by a CVD, PECVD, or a spin-on process. A high temperature bake of up to 600° C. may be required following formation of the dielectric layer 33 for annealing purposes. A cap layer 34 which can be silicon nitride or silicon oxynitride is deposited by a CVD or PECVD process and serves as an etch barrier during a subsequent planarization step. Optionally, an anti-reflective coating (ARC) which is not shown can be formed on the cap layer 34 to optimize the process latitude during a subsequent photoresist patterning step.

A photoresist layer 35 is coated on cap layer 34 and is patterned by a conventional method to form an opening 36, such as a contact hole that is aligned above metal layer 31, in the photoresist layer 35. It should be understood that the pattern in the photoresist layer 35 also contains other holes (not shown) that may be isolated with no close neighboring holes or that may be densely arranged where one hole is separated from one or more others by a distance that approaches the width of a contact hole. The etch process transfers the opening 36 through the stack while maintaining the width of the opening 36 and does so in a uniform manner, so that a layer is removed within an opening 36 at about the same rate as the same layer is removed from another opening (not shown) in the pattern. For instance, holes located near the edge of substrate 30 may be etched more quickly than holes near the center of substrate 30. A method is described herein that provides for a more uniform etch rate between the center and edge of substrate 30.

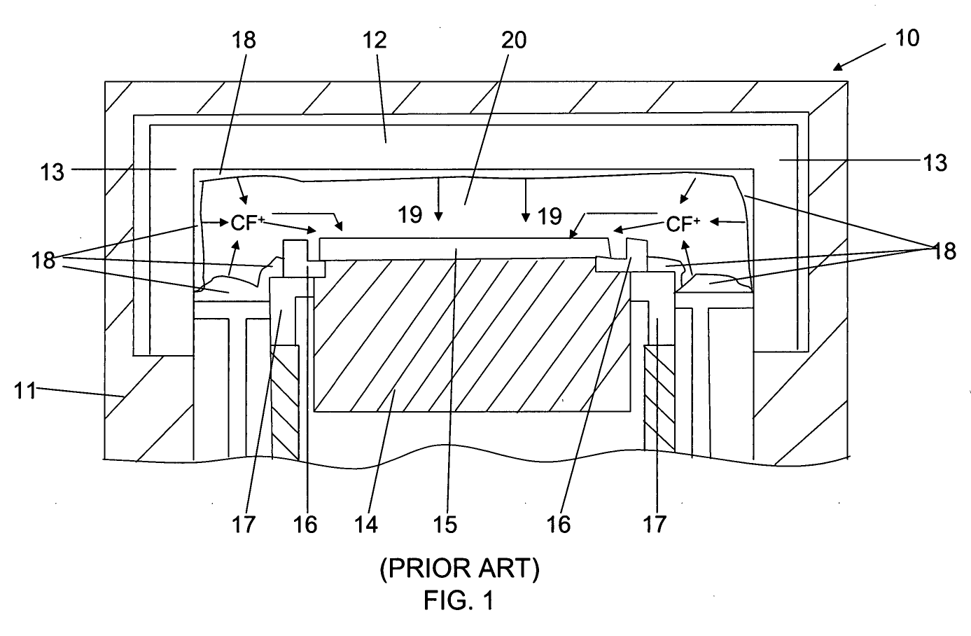

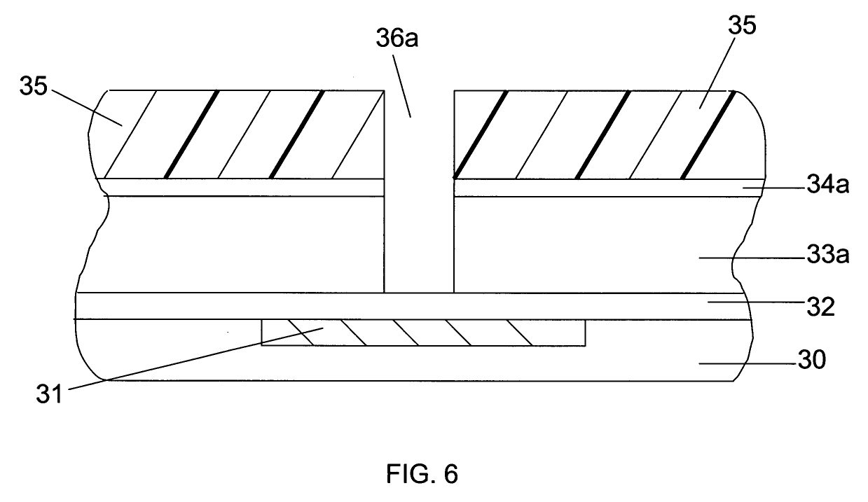

FIG. 6 is a schematic cross sectional drawing showing a contact hole structure formed in a stack structure. The opening 36a is formed within the photoresist layer 35, the cap layer 34a and the dielectric layer 33a. Referring to FIG. 6, the method loads the substrate 30 in a process chamber as shown in FIG. 1, except that the process chamber 10 is equipped with the focus ring 24 on the support ring 17 shown in FIG. 4. The substrate 30 has a shape similar to the wafer 15 and is positioned on the stage 14 in place of the wafer 15. In this embodiment, the substrate 30 has a 200 mm diameter but a similar etch chamber and focus ring 24 are also available for a 300 mm diameter substrate 30.

The opening 36 is transferred through the cap layer 34 by a plasma etch process involving CₓH_{y}F_{z} where x and z are not less than 1 and y is not less than 0. Additional gases such as an oxygen containing gas and an inert gas may be combined with the fluorocarbon gas to generate a plasma. Some polymer buildup can occur on various parts of the process space in the etch chamber, but none is formed on the support ring 17 which is covered by the focus ring 24 as depicted in FIG. 4. Returning to FIG. 6, the etch process continues for a prescribed amount of time or until an end point detect instrument connected to the process chamber indicates that a portion of the cap layer 34 is removed. Optionally, the etch may continue for a certain amount of time beyond the end point in order to compensate for some nonuniformity in the etch rate across the substrate 30. Some of the photoresist layer 35 that serves as an etch mask is likely to be removed during the etch process, through the cap layer 34 in the opening 36.

The substrate 30 remains in the process chamber while a second plasma etch step is performed to transfer the opening 36 through the dielectric layer 33. Gases may be purged from the process chamber after the cap layer 34a etch is complete and a new gas mixture is fed into the process space for a short period before a second plasma is struck. In this embodiment, CₓH_{y}F_{z} may be employed to remove a portion of the dielectric layer 33. An oxygen containing gas may or may not be used. Additionally, an inert gas such as helium, argon or nitrogen may be combined with the reaction gas. The focus ring 24 shown in FIG. 4 keeps fluorocarbon polymer from collecting on or near to the edge of the support ring 17 during this etch step and thereby prolongs the time between preventative maintenance operations and wet clean steps to maintain the process chamber in good working order. Furthermore, the focus ring 24 improves etch uniformity during removal of the dielectric layer 33 from the opening 36 and similar openings in the pattern. The etch through the dielectric layer 33 is likely to remove some of the photoresist layer 35.

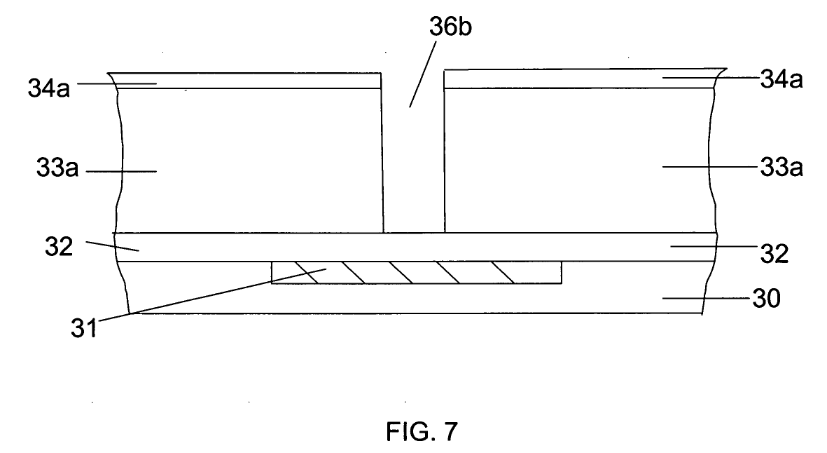

Referring to FIG. 7, the photoresist layer 35 is stripped by an ashing process that involves a plasma etch which is preferably formed from a gas mixture comprised of a fluorocarbon and oxygen. The ashing process takes place in the same process chamber as employed for etching the cap layer 34 and dielectric layer 33 but alternatively can be performed in a different chamber that has a wide style focus ring having a location, shape, and size as described for the focus ring 24 shown in FIG. 4. In some embodiments, the oxygen content during this ashing step is higher than in the previous etch steps in which the photoresist layer 35 acts as an etch mask. As described above with reference to the previous etch step, the gases in the chamber may be evacuated before a new gas mixture is fed into the chamber and a plasma is generated. The ashing step completely removes the photoresist 35 and any other organic layers that are optionally used on the dielectric stack (such as an ARC layer which is not included in the drawing) so as to form the opening 36b within the cap layer 34a and the dielectric layer 33a. The focus ring 24 keeps fluorocarbon polymer from collecting on an underlying support ring and improves etch rate uniformity across the substrate 30.

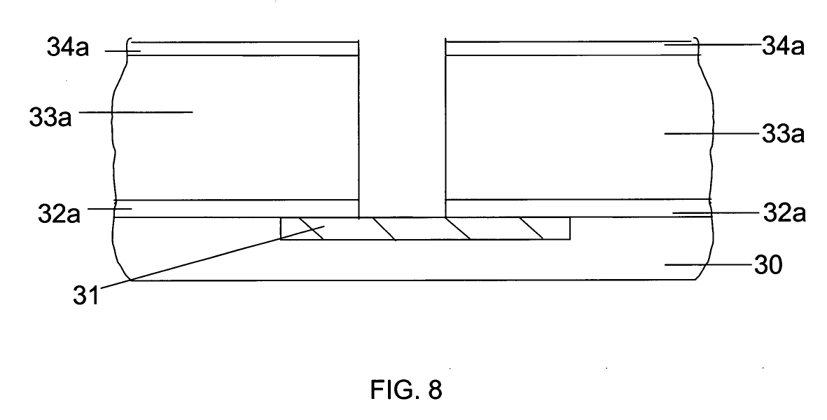

Referring to FIG. 8, a contact hole structure is completed by removing a portion of the etch stop layer 32 at the bottom of opening 36 by an etch process. The contact hole structure depicted in FIG. 8 is formed with an improved performance compared to prior art methods since cap layer 34a has a smoother surface due to a more uniform etch during removal of photoresist 35. A smooth surface enables other layers to be coated more evenly on cap layer 34a and leads to a higher performing device. Additionally, fewer particle defects are formed during the etch steps through cap layer 34a and dielectric layer 33a. Fewer defects mean that the opening 36c and other openings in the pattern formed in the stack are cleanly formed and are not obstructed by particles.

Although the present invention has been described in terms of exemplary embodiment, it is not limit thereto. Rather, the appended claims should be constructed broadly to include other variants and embodiments of the invention which may be made by those skilled in the field of this art without departing from the scope and range of equivalents of the invention.

What is claimed is:

1. An apparatus in a chamber, comprising:
a stage;
a support ring around the stage; and
a focus ring over the stage and the support ring, substantially completely covering a top surface of the support ring.

2. The apparatus of claim 1, wherein the focus ring further covers a portion of a sidewall of the support ring.

3. The apparatus of claim 2, wherein an outer diameter of the focus ring is not less than about 280 mm.

4. The apparatus of claim 1, wherein the focus ring comprises:
an inner portion for supporting a perimeter of a wafer; and
an outer portion adjacent to the inner portion, bottom surfaces of the inner portion and the outer portion substantially covering a part of a stage so as to prevent formation of particles on or near to an edge of the stage.

5. Etching apparatus comprising:
a chamber comprising:
a stage;
a support ring around the stage, and
a focus ring over the stage and the support ring, substantially completely covering a top surface of the support ring;
a vacuum system that evacuates the chamber;
a gas source for providing a gas to the chamber for forming a plasma;
means for generating an electric field in the chamber; and
means for generating a magnetic field in the chamber.

6. The apparatus of claim 5, wherein the focus ring further covers a portion of a sidewall of the support ring.

7. The focus ring of claim 6, wherein an outer diameter of the focus ring is not less than about 280 mm.

8. The etching apparatus of claim 5, wherein the apparatus is a dipole ring magnet etching apparatus.

9. The etching apparatus of claim 8, wherein the magnetic field generating means comprises a plurality of magnetic elements arranged in a circle around said container so as to form a ring.

10. A method for forming a contact hole structure, comprising:
providing a substrate over a stage with a support ring around the stage, and a focus ring substantially completely covering the support ring; and
performing an etch process so as to form a contact hole structure in the substrate substantially without forming particles on or near to an edge of the support ring.

11. The method for forming a contact hole structure of claim 10, wherein an outer diameter of the focus ring is not less than about 280 mm.

12. The method for forming a contact hole structure of claim 10, wherein the etch process uses CₓH_{y}F_{z} gas, wherein x and z are not less than 1, and y is not less than 0.

13. The method for forming a contact hole structure of claim 12, wherein the etch process further uses an inert gas.

14. The method for forming a contact hole structure of claim 12, wherein the etch process further uses an oxygen containing gas.

15. A contact hole structure formed by the method of claim 12.

16. The contact hole structure of claim 15, wherein an outer diameter of the focus ring is not less than about 280 mm.

17. The contact hole structure of claim 15, wherein the etch process uses CₓH_{y}F_{z} gas, wherein x and z are not less than 1, and y is not less than 0.

18. The contact hole structure of claim 17, wherein the etch process further uses an inert gas.

19. The contact hole structure of claim 17, wherein the etch process further uses an oxygen containing gas.
